(19) United States
(12) Patent Application Publication
(10) Pub. No.: US 2023/0294331 A1
(43) Pub. Date: Sep. 21, 2023

(54) A GRANULAR INFILL MATERIAL AND A PROCESS FOR PRODUCING THE GRANULAR INFILL MATERIAL

(71) Applicant: POLYGREEN SRL, Desenzano Del Garda (IT)

(72) Inventor: Roberto DIAN, Sirmione (IT)

(21) Appl. No.: 17/642,121

(22) PCT Filed: Nov. 13, 2021
(86) PCT No.: PCT/IT2021/050330

§ 371 Date: Mar. 10, 2022

(30) Foreign Application Priority Data
Nov. 18, 2020 (IT) 102020000027594

(51) Int. Cl. B29B 17/04; E01C 13/08

(52) U.S. Cl. CPC B29B 17/0412; E01C 13/08

(57) ABSTRACT

A disclosed process for producing granular infill material for a synthetic turf surface includes providing scraps of a composite material comprising a textile support. A coating of the textile support includes a polymeric material. A weight percentage of the textile support is greater than or equal to 5% of a total weight of the composite material. The production process includes grinding the scraps to obtain scrap pieces, preparing a mixture comprising the scrap pieces, and heating the mixture to obtain a blend comprising the polymeric material in a softened state and pieces of the textile support dispersed in the polymeric matrix. A plurality of solid granules may be obtained from the blend to make the granular infill material. Each granule includes a polymeric matrix including the polymeric materials and a reinforcing filler dispersed in the polymeric matrix. The reinforcing filler may include pieces of the textile support.

### TECHNICAL FIELD OF THE INVENTION

The present invention relates to a production process of granular infill material for a synthetic turf surface and a granular infill material.

### STATE OF THE ART

In the making of surfaces for sports use (e.g., soccer fields, football fields, rugby fields, baseball fields, etc.) and/or for decorative use (e.g., gardens), a rigid and compact substrate, for example in clay or asphalt, is typically prepared above which a synthetic turf mat is laid, which is a mat comprising artificial fibres simulating the natural grass. Furthermore, a layer of, typically granular, material called infill (which can be made of various materials such as rubber granules, even recycled rubber granules, sand, plant material such as cork and/or coconut, etc.) is typically spread on the synthetic turf mat between the artificial fibres. The infill structurally stabilizes the synthetic turf mat and/or improves its aesthetic quality, making it look more likely to the natural grass (as it facilitates the upright position of the artificial fibres) and/or facilitates its use for sports improving its performance properties (for example in terms of elastic response of the mat, rolling/bouncing of the ball, etc.).

Patent EP3452660B1 of the same Applicant discloses a granular infill material.

### SUMMARY OF THE INVENTION

The Applicant has observed that some known granular infill materials tend to undergo a dimensional deformation over time (e.g., typically a crushing) when subjected to normal treading stresses during the use of the synthetic turf mat. This deformation of the granules in turn causes a loss of performance properties of the granular infill material which, for example, causes an increase in the wear of the surface of the synthetic turf mat (e.g., since the crushing involves a decrease in the volume of the granules and consequently a greater portion of the artificial fibres that is left free and subjected to wear during the use of the surface) and/or a loss of performance properties, such as the ability to efficiently cushion the stresses to which the mat is subjected during use (causing for example a decrease in comfort for the users and/or an increase in the injuries risk, typically joint injuries).

The Applicant has also observed that some known granular infill materials have inadequate water-retaining properties. In particular, the Applicant believes that the materials used to make these granular infill materials have an inadequate hygroscopicity (i.e., ability to absorb humidity in the air) and/or an inadequate hydrophilicity (i.e., ability to absorb water in liquid form, e.g., rain or actively sprayed on the mat). These unsatisfactory water-retaining properties can lead to an overheating risk of the synthetic turf mat (for example due to solar radiation), with consequent deterioration or damage to the mat structure, and/or a decrease in the comfort for the users of the mat and/or an increase of sprayed water consumption.

The Applicant has therefore faced the problem of making, through an ecological production process, a granular infill material for synthetic turf surfaces, which is endowed with the desired performance properties, for example in terms of mechanical and/or water-retaining properties.

According to the Applicant, the above problem is solved by a production process of a granular infill material for synthetic turf surfaces and a granular infill material according to the attached claims and/or having one or more of the following features.

According to an aspect the invention relates to a production process of a granular infill material for a synthetic turf surface, the process comprising:
providing scraps of at least one composite material comprising a textile support and a coating of said textile support made of polymeric material, wherein a weight percentage of said textile support is greater than or equal to 5% of a total weight of said composite material;
grinding said scraps for obtaining scraps pieces;
preparing a mixture comprising said scraps pieces;
heating said mixture for obtaining a blend comprising said polymeric material in softened state and pieces of said textile support dispersed in said polymeric material;
starting from said blend, obtaining a plurality of solid granules for making said granular infill material, wherein each of said granules comprises a polymeric matrix comprising said polymeric material and a reinforcing filler dispersed in said polymeric matrix, said reinforcing filler comprising said pieces of textile support.

According to an aspect the invention relates to a granular infill material for a synthetic turf surface, said granular infill material comprising a plurality of granules each comprising a polymeric matrix comprising a polymeric material and a reinforcing filler dispersed in said polymeric matrix and comprising pieces of a textile support.

Preferably said polymeric matrix and said reinforcing filler at least partially derive from scraps of at least one composite material comprising said textile support and a coating of said textile support made of said polymeric material, wherein a weight percentage of said textile support is greater than or equal to 5% of a total weight of said composite material. According to the Applicant, it is advantageous producing granular infill materials starting from scraps of at least one composite material, such as for example scraps deriving from trimming in the production of sheets of composite material and/or deriving from the cutting of shapes from sheets of composite material during the production of articles made of composite material, or production batches of composite material that do not pass the quality tests, or even flaps of composite material recovered from end-of-life articles.

The Applicant has realized that the aforesaid composite materials comprising a textile support coated with polymeric material are particularly suitable to be used as raw material for the production of the granules, since the pieces of the textile support make (or contribute to make) the reinforcing filler of the granule, while the polymeric material makes (or contributes to make) the polymeric matrix of the granule in which the reinforcing filler is dispersed. It is noted that the aforesaid composite materials are generally considered to be difficult to recycle, since it is typically necessary separating the polymeric material from the textile support, which is a laborious and costly operation. Instead, the Applicant has realized that it is possible using scraps of composite material for the production of granules without the need to separate the textile part from the polymeric coating, and indeed by exploiting the composite structure of the material.

Furthermore, the Applicant has found that the granular infill material according to the present invention has a high structural stability. The Applicant has in fact experimentally observed that the pieces of textile support, during the heating of the aforesaid mixture, typically do not undergo a complete melting, or even remain substantially intact (e.g., since the materials that make up the textile support have a higher melting point than the polymeric material and/or are materials that do not undergo melting). According to the Applicant (without restricting to any theory), these pieces of textile support (typically in fibre form) create a reinforcing structure (e.g., reticular reinforcing structure) which acts as a structural “skeleton” of the granule making possible maintaining over time the dimensional properties of the granule, even in face of the stresses underwent by the granule during use. This maintenance of the dimensional properties also results in less wear underwent by the granule itself and in a maintenance over time of the performance properties of the granule, e.g., in terms of wear of the synthetic turf surface (e.g., of the mat) and/or shock absorption. The Applicant believes that the aforesaid weight content of the textile support which is greater than or equal to about 5% of the total weight of the composite material favours the formation of this reinforcing structure (see also below regarding the known use of wallpaper as scrap material, which however has a weight content of textile fibres from zero to 3%).

The Applicant has also found that the granular infill material according to the present invention has high water-retaining properties. The Applicant has experimentally observed that the granules thus obtained have pores on their outer surface, which according to the Applicant, without restricting to any theory, are created during the production process of the granules due to the presence of the (typically fibrous) pieces of textile support. According to the Applicant, these pores allow entrapping micro-drops of water, e.g., rain, and/or actively sprayed on the synthetic turf, providing the desired water-retaining ability to the granular infill material. In this way, the overheating of the synthetic turf surface above which the granular infill material is arranged is limited, thus limiting the damaging of the surface and/or increasing the ergonomics of the surface for the users. Furthermore, the Applicant believes that the high dimensional stability of the granule given by the reinforcing structure (as explained above), allows maintaining these water-retaining properties substantially unchanged over time since, even in face of the stresses underwent by the granule during use, there is no collapse of the structure of the granule with consequent occlusion (of at least part) of the pores.

It is also noted that the production cost of the aforesaid granular infill material is low since the purchase cost of part of the raw material, i.e., the scraps of composite material, is very low, or substantially null. In fact, for the manufacturers of the articles from which the scrap materials derive, the disposal of such scrap materials is an onerous operation both in terms of disposal costs/times and executive procedures that must be followed for proper disposal. Therefore, these scrap materials are available from the aforesaid manufacturers at very low or substantially null costs, as they typically constitute a task. Furthermore, recycling scrap materials that otherwise would have to be disposed with the consequent risk of environmental pollution and/or resources waste contributes to environmental protection and a circular economy. Finally, such scraps of composite material are available in large quantities as they are used in various industrial sectors, such as the automotive sector (for example for seat covers, headrest covers, armrest covers, etc., and/or for internal trims, etc.), the clothing and accessories sector (e.g., for bags, clutches, wallets, document holders, briefcases, etc.), the footwear sector (e.g., for upper, tongue, quarter, throat and/or heel/toe area of shoes), the furniture sector (e.g., sofas, armchairs, poufs), etc.

The present invention in one or more of the aforesaid aspects can have one or more of the following preferred features.

Preferably said at least one composite material, more preferably each composite material, is imitation leather (for example Alcantara™, Ultrasuede™, Feel Tek™, etc). “Imitation leather” means a material having tactile and/or aesthetic properties similar to those of the natural leather (typically at least at said polymeric material). In fact, the Applicant has experimentally found that the composite materials generally used for reproducing the leather are particularly suitable, due to their chemical-physical composition, for obtaining one or more of the aforesaid technical effects (e.g., the reinforcing structure, the water-retainment and/or the large availability).

Typically, said coating of the textile support is made impregnating (such as for Alcantara™) and/or spreading (such as for Feel Tek™) said textile support with said polymeric material.

Preferably said weight percentage of textile support is greater than or equal to 8%, more preferably greater than or equal to 10%, and/or less than or equal to 40%, more preferably less than or equal to 30%. In this way it is possible improving the aforesaid reinforcing structure of the granule. In fact, the weight percentage of textile support within the aforesaid range optimizes the fibres content in the granule for the purpose of the reinforcing structure of the granule.

Preferably said scraps comprise scraps of two or more composite materials different from each other, i.e., said scraps are heterogeneous. In other words, a textile support and/or a coating made of polymeric material of at least a first sub-group of scraps differs respectively from a textile support and/or a coating made of polymeric material of a second sub-group of scraps. The Applicant has in fact surprisingly found by experimental tests that it is possible obtaining granules having the desired performance properties even starting from heterogeneous scraps in the type of composite material (for example different types of imitation leather or different structures of the same type of imitation leather), for example coming from different industrial sectors. The Applicant has realized that the use of the aforesaid heterogeneous scraps allows reducing the sorting operations of the scraps based on the type of textile support and/or polymeric material making up the coating. These operations are in fact laborious in terms of time spent and/or personnel used.

Preferably said at least one composite material, more preferably each of said composite materials, comprises a weight percentage of said polymeric material greater than or equal to 50%, more preferably greater than or equal to 60%, even more preferably greater than or equal to 70%. In this way the polymeric material is in sufficient amount to form the polymeric matrix that covers the reinforcing filler.

Preferably said polymeric material is selected in the group: polyvinylchloride (PVC), polyurethane (PU), polyester (for example polyethylene-terephthalate (PET)), polypropylene (PP), or mixtures thereof. More preferably said polymeric material is polyvinylchloride (PVC) or polyurethane (PU). These materials are the materials most widely used for making the coating of the textile support, in particular polyurethane and polyvinylchloride are used by the manufacturers of articles made of imitation leather, and at the same time are suitable for the production of granules for infills.

In one embodiment said grinding said scraps comprises micronizing said scraps, preferably for obtaining said scraps pieces with dimensions less than or equal to 0.3 mm, more preferably less than or equal to 0.2 mm, even more preferably less than or equal to 0.1 mm.

In one embodiment said polymeric matrix comprises only said polymeric material coming from said scraps. In this way the production costs are minimized and the production process of the granules is simplified.

In one embodiment said preparing said mixture comprises adding to said scraps pieces a (respective) amount of one (or more) further polymeric material not coming from said scraps, more preferably in the form of granules of said further polymeric material.

In one embodiment said polymeric matrix comprises an amount of one (or more) further polymeric material not coming from said scraps. Preferably said further polymeric material is selected in the group: polyvinylchloride, polyurethane, polyester (for example PET), polypropylene. Said further polymeric material can be the same as said polymeric material or different from said polymeric material (e.g., both are polyurethane or polyvinylchloride). Preferably said further polymeric material comes from the grinding of article scraps made of said further polymeric material, the article scraps being devoid of textile support. In this way it is possible balancing the chemical composition of the polymeric matrix to obtain the desired properties, depending on the starting composition of the scraps. According to the Applicant, especially in case of scraps of composite material wherein the weight percentage of polymeric material is low, the amount of polymeric material deriving from such scraps is insufficient to effectively incorporate the reinforcing filler of the granule. Therefore, according to the Applicant, it is appropriate to carry out an ennobling process of the granule by adding an amount of a further polymeric material that allows an increase in the performance properties of the granule (e.g., decrease in the wear of the surface, decrease in the abrasion risk and increase in stresses cushioning). This further polymeric material can be new or recycled material, for example coming from the grinding of scraps of an imitation leather comprising said further polymeric material and devoid of textile support, such as that used in the automotive sector to make dashboards.

Preferably heating said mixture comprises bringing said blend to a temperature greater than or equal to 130° C., more preferably greater than or equal to 160° C., and less than or equal to 220° C., more preferably less than or equal to 180° C. This temperature allows the homogeneous softening of the polymeric material, and possibly also of the further polymeric material added, even in presence of scraps of composite material wherein there is heterogeneity of polymeric material that makes up the respective coating and/or in case the further polymeric material differs from the polymeric material that makes up the coating.

Preferably heating said mixture comprises bringing said blend to a temperature greater than or equal to a melting temperature of said polymeric material and less than or equal to a melting temperature of a material of said textile support. In this way, it is possible avoiding a total fusion also of the pieces of textile support which make up the reinforcing filler of the granules, thus creating the reinforcing structure of the granule.

Preferably said reinforcing filler comprises a network of textile fibres (e.g., in the form of straws and/or in the form of microfilaments) originating from said pieces of textile support. In this way, the aforesaid reinforcing structure of the granule is made. In particular, the Applicant believes that the individual textile fibres significantly contribute to the making of the reinforcing structure.

Preferably said textile support comprises textile fibres. Preferably said textile support is made of natural textile fibres (e.g., cotton and/or wool fibres), synthetic textile fibres (polyester, aramids - e.g., nylon) and/or mixtures thereof. In this way it is possible simply making the aforesaid reinforcing network of the granule, since materials having a higher melting point than that of the polymeric material that covers the textile support are used. Consequently, in the blend there is substantially only the fusion of the polymeric material, with the pieces of textile support which maintain a structure for making the aforesaid reinforcing network.

Preferably said textile support is made of any type of fabric, more preferably selected from: knitted fabric (e.g., weft-knitted and/or warp-knitted fabric), warp and weft fabric (e.g., woven fabric), non-woven fabric, or combinations thereof.

Typically, said at least one composite material, or each composite material, is different from wallpaper. The wallpaper is typically made of a paper support spread with a vinyl material (typically PVC). Occasionally, the wallpaper may contain a low content of textile fibres (typically made of polyester) in various forms (e.g., loose fibres distributed in the paper support or fibres that form a non-woven fabric interposed between the paper support and the vinyl coating). However, the weight percentage of such textile fibres, when present, is less than 3% of the total weight of the wallpaper, and according to the Applicant this content as such is insufficient to give the above-described effects (e.g., to create the aforesaid reinforcing structure of the granule and/or the formation of the aforesaid pores on the surface of the granule).

In one embodiment said preparing said mixture comprises adding to said scraps pieces an amount of wallpaper scraps pieces. Preferably said amount of wallpaper scraps pieces is less than or equal to 55%, more preferably less than or equal to 50%, even more preferably less than or equal to 45%, of a mass of said scraps pieces of composite material. According to the Applicant, as above-mentioned, also the wallpaper has a structure that makes it suitable for processing in combination with scraps of composite materials. In fact, the paper (cellulose) can help to make the reinforcing filler while the polymer (typically PVC) can help to make the polymeric matrix.

Preferably each of said granules comprises a respective plurality of textile fibres which protrude from an outer surface of said granule. In this way it is possible further improving the water-retaining properties of the granule and providing stability properties to the granular infill material. The Applicant has experimentally observed that from the outer surface of the granule some textile fibres protrude (in the form of straws or microfilaments) originating from the pieces of textile support. These textile fibres, according to the Applicant, without restricting to any theory, gives a double advantage to the granular infill material. In fact, on the one hand, they increase the water-retaining properties as they allow entrapping micro-drops of water on the outer surface of the granule, and on the other hand, they allow limiting, or avoiding, the accumulation of granules in the side areas of the synthetic turf surface (for example the accumulation is due to the running of the athletes and/or to the rebound of the ball) and/or during atmospheric precipitation (e.g., washout), since the textile fibres of adjacent granules interlace to form a “tangle” that stabilizes the position of the granules on the synthetic turf surface.

In one embodiment said reinforcing filler comprises only said pieces of textile support, more preferably said network of textile fibres. In this way the production costs are minimized and the production process of the granules is simplified.

In one embodiment said preparing said mixture comprises adding to said scraps pieces an amount of a reinforcing material not coming from said scraps.

In one embodiment said reinforcing filler comprises an amount of a reinforcing material not coming from said scraps. Preferably said reinforcing material is a mineral material and/or a plant material. Preferably said mineral material is selected in the group: calcium carbonate, talc, kaolin, sand, lime, or combinations thereof. Preferably said plant material is selected in the group: coconut fibre/peat, cork, rice husk, banana fibre/peat, lignin, cellulose, tree defibration, hemp, or combinations thereof.

In this way, according to the Applicant, it is possible further improving the dimensional stability properties of the granule and limiting the production costs of the granular infill material given the low costs of the materials used as reinforcing material.

In one particularly preferred embodiment, said reinforcing material is calcium carbonate. Preferably said preparing of said mixture comprises adding to said scraps pieces one or more additives, preferably selected among flame retardants, anti-oxidants, anti-UV rays and/or dyes. In this way it is possible simply providing particular properties to the granular infill material.

Preferably said heating said mixture comprises feeding said mixture to an extruder. In this way, the heating of the mixture is simply carried out.

In one embodiment said obtaining said solid granules comprises extruding said blend and cutting said blend preferably through a blades/counter-blades cutting system positioned downstream of the extruder. In this way the granulation for obtaining the granules is rapidly carried out.

In one embodiment said obtaining said solid granules comprises extruding a plurality of sizes of said blend and grinding said sizes of blend. In this way it is possible efficiently controlling the granulation parameters, thus obtaining granules having the desired size. According to a further aspect, the invention relates to a synthetic turf surface comprising a synthetic turf mat and a layer of said granular infill material according to any embodiment of the present invention arranged above said synthetic turf mat. In this way, the desired performance and/or aesthetic properties are provided to the synthetic turf surface, for example in terms of wear resistance and/or low abrasion risk for the users and/or adherence for the users and/or likelihood to the natural grass.

Preferably said layer of granular infill material has a mass per unit area greater than or equal to 3 kg/m², more preferably greater than or equal to 8 kg/m², and/or less than or equal to 20 kg/m², more preferably lower or equal to 10 kg/m². In this way, the appropriate amount of granular infill material is provided for giving the desired performance/aesthetic properties.

### BRIEF DESCRIPTION OF THE DRAWINGS

FIG. 1 schematically shows in vertical section a synthetic turf surface comprising a layer of granular infill material according to the present invention;

FIG. 2 shows a block diagram of a production process of a granular infill material according to the present invention.

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures.

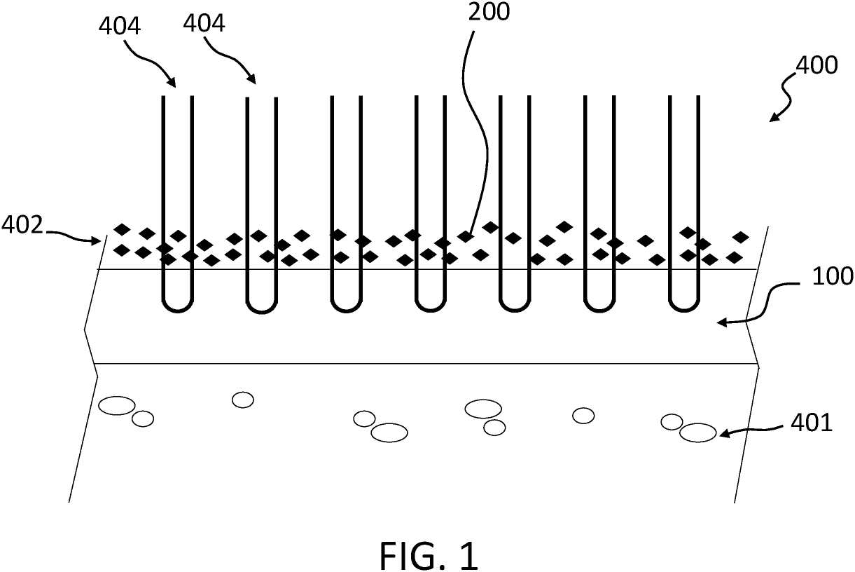

With reference to FIG. 1, it is schematically shown a synthetic turf surface 400 comprising a compact clay substrate 401 (for example as known), on which a synthetic turf mat 100 is laid, not further described as, for example, of known type, and at least one layer of granular infill material 402 (comprising a plurality of granules 200) arranged on the synthetic turf mat 100 between the artificial fibres 404 of the mat 100 (which simulate the grass thread). Exemplarily the layer of granular infill material 402 has a mass per unit area equal to about 8 kg/m². In some embodiments, two or more superimposed layers of granular material of different composition are provided. Typically, the granular material of the present invention is a performance infill and therefore is arranged at the top of the infill.

The synthetic turf surface 400 is not further described and illustrated as known per se.

Preferably each granule 200 comprises a polymeric matrix comprising a polymeric material and a reinforcing filler dispersed in the polymeric matrix comprising pieces of a textile support, with at least part of the polymeric matrix and the reinforcing filler deriving from scraps of at least one composite material which comprises the textile support and a coating of the textile support in the polymeric material, wherein a weight percentage of the textile support is greater than or equal to 5%.

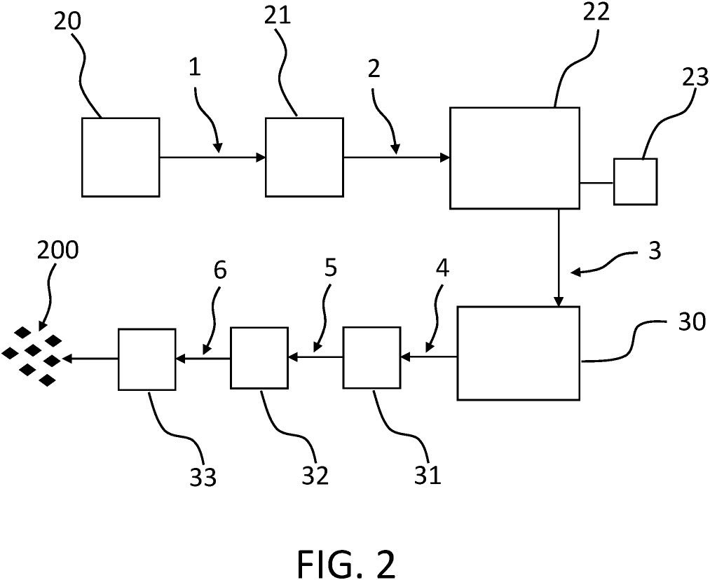

Exemplarily these composite materials are imitation leather wherein the coating of the textile support is made by spreading the textile support with the polymeric material. With reference to FIG. 2, the reference number 20 schematically indicates a container for collecting scraps 1 of the composite materials, for example scraps of imitation leather. After collection, the process comprises grinding the scraps to obtain scraps pieces 2. The grinding is exemplarily carried out by feeding such scraps 1 to one or more grinding mills 21 (only schematically shown) in which for example there is a respective blades/counter-blades system (for example of known type). For example, the grinding can comprise a coarse pre-grinding of the scraps 1 and a subsequent micronation for obtaining scraps pieces 2 having spatial dimensions of about 0.1 mm. The grinding operation of the scraps 1 is not further described as for example of known type.

At this point, the process comprises preparing a mixture 3 comprising the scraps pieces 2. Exemplarily the preparation of the mixture 3 is carried out inside special mixing devices 22 (only schematically shown and for example of known type) in which the ground scraps pieces 2 are conveyed.

In one embodiment, the preparation of the mixture 3 comprises adding to the scrap pieces 2 an amount, exemplarily in granular form, of a further polymeric material not coming from the scraps 1. This further polymeric material can be new raw material or come from the grinding of articles scraps made of the further polymeric material and devoid of textile support, such as scraps of imitation leather from the automotive sector. In the latter case, these articles scraps can alternatively be directly collected (e.g., in the container 20) and/or ground (e.g., in the grinding mill 21) together with the scraps 1 of composite material.

In one embodiment the preparation of the mixture 3 comprises adding to the scrap pieces 2 an amount of wallpaper scraps (typically comprising paper and PVC), for example directly collected (e.g., in the container 20), and/or ground (e.g., in the grinding mill 21), together with the scraps 1 of composite material.

In one embodiment, the preparation of the mixture 3 comprises adding to the scrap pieces 2 an amount of a reinforcing material not coming from the scraps 1.

Advantageously, the choice of the possible combination of heterogeneous composite materials in the initial scraps 1, and/or of the type and amount of further polymeric material, of the reinforcing material and/or of the wallpaper is made case by case according to the starting materials and to the final composition of the granule 200 to be obtained. Typically, in the granule 200, the part of polymeric matrix is globally equal to 60-70% of the total weight, the rest being substantially reinforcing filler (except for the additives and any impurities).

In one embodiment the preparation of the mixture 3 comprises adding to the scrap pieces 2 flame retardant additives, anti-oxidant additives, anti-UV ray additives and/or dye additives.

Once the preparation of the mixture 3 has been completed inside the mixing device 22, the latter acts as a tank for feeding the mixture 3 to an extruder 30 (only schematically shown and for example of known type).

For example, the mixing device 22 comprises a stirring and feeding device 23 (only schematically shown) which carries out a forced mixing of the mixture 3 and the feeding of a predetermined amount of mixture 3 inside the extruder 30.

Following the feeding of the mixture 3 into the extruder 30, the process comprises heating the mixture 3, exemplarily to a temperature equal to about 180° C., for obtaining a blend comprising the polymeric material (coming from the scraps 1, with possibly also the added polymeric material, such as the further polymeric material or the one coming from the wallpaper) in a softened state and pieces of the textile support (coming from the scraps 1, with possibly also the paper pieces coming from the wallpaper or the reinforcing material) dispersed in the polymeric material. Exemplarily the heating temperature is less than or equal to the melting temperature of the material of the textile support, for making a network of textile fibres, for example in straws form, originating from the textile support. Exemplarily the extruder 30 comprises a series of heating elements (of known type, not shown) and an extrusion screw (not shown and also of known type) suitable for allowing the movement and homogenization of the blend inside the extruder 30.

Exemplarily the mixture 3 fed into the extruder 30 enters, by rotation of the extrusion screw, in a compression area wherein the blend is formed, with the polymeric material that softens when subjected to strong pressures and heat application.

Subsequently, the blend is moved towards the extrusion/outlet head of the extruder 30 for being extruded.

Exemplarily the blend is extruded in the form of sizes 4, and for example these sizes 4 (typically in fluid form) undergo a first fragmentation by a cutting blade 31 (schematically shown and for example of known type).

Exemplarily the fragmented sizes 5 are subsequently fed to a transport screw 32 (schematically shown and for example of known type) in which, for example, a second fragmentation of the fragmented sizes 5 takes place.

Exemplarily the transport screw 32 then feeds the sizes pieces 6 (formed after the second fragmentation) to a grinding device 33, for example a grinding mill as those above-described, in which the grinding of the sizes pieces 6 exemplarily takes place for obtaining the granules 200 (exemplarily each one comprising a respective plurality of textile fibres which protrude from an outer surface of the granule).

Optionally, the granules 200 thus obtained can be subsequently fed into a sieving device (for example a vibrating screen with superimposed sieves in which there are a plurality of openings having different dimensions) which allows the removal of possible cutting powders and/or the subdivision of the granules 200 according to the granulometry. The average size of the granules ranges from about 2 mm to 5 mm.

In the following some examples of production processes of the granules 200 according to the present invention are described.

### Example 1

Composition of the scraps 1 of composite material: imitation leather (single type) with textile support 20% and polymeric material 80%;
Type and material of the textile support, knitted fabric made of polyester (PET) and cotton;
Polymeric material: polyvinylchloride (PVC);
Further polymeric material: absent;
Wallpaper scraps: absent;
Reinforcing material: calcium carbonate;
Additives: anti UV rays, flame retardants and dyes.

### Example 2

Composition of the scraps 1 of composite material: imitation leather (single type) with textile support 30% and polymeric material 70%;
Type and material of the textile support: knitted fabric made of cotton;
Polymeric material: polyvinylchloride (PVC);
Further polymeric material: polyvinylchloride (PVC);
Wallpaper scraps, absent;
Reinforcing material: calcium carbonate;
Additives: anti UV rays, flame retardants and dyes.

### Example 3

Composition of the scraps 1 of composite material: imitation leather (heterogeneous):
   33% first sub-group: textile support 10% and polymeric material 90%,
   33% second sub-group: textile support 25% and polymeric material 75%,
   33% third sub-group: textile support 35% and polymeric material 65%;
Type and material of the textile support:
   first sub-group: knitted fabric made of polyamide,
   second sub-group: knitted fabric made of polyester,
   third sub-group: knitted fabric made of cotton;
Polymeric material:
   first and second sub-group: polyvinylchloride (PVC),
   third sub-group: polyurethane (PU);
Further polymeric material: combination of polyvinylchloride (70%) and polyurethane (30%);
Wallpaper: absent;
Reinforcing material: calcium carbonate;
Additives: anti UV rays, flame retardants and dyes.

### Example 4

Composition of the scraps 1 of composite material: imitation leather (single type) with textile support 25% and polymeric material 75%;
Type and material of the textile support: knitted fabric made of polyester (PET) and cotton;
Polymeric material: polyurethane (PU);
Further polymeric material: recycled polyurethane;
Wallpaper: weight content equal to about 20% of the total weight of the scraps 1;
Reinforcing material: calcium carbonate;
Additives: anti UV rays, flame retardants and dyes.

1-10. (canceled)

11. A process for producing a granular infill material for a synthetic turf surface, the process comprising:
providing scraps of a composite material comprising a textile support and a coating of the textile support, wherein the coating comprises a polymeric material and wherein a weight percentage of the textile support is at least 5% of a total weight of the composite material;
grinding the scraps to obtain scrap pieces;
preparing a mixture comprising the scrap pieces;
heating the mixture to obtain a blend comprising:
the polymeric material in softened state; and
pieces of the textile support dispersed in the polymeric material;
obtaining, from the blend, a plurality of granules for the granular infill material, wherein each of the granules comprises:
a polymeric matrix, wherein the polymeric matrix includes the polymeric material; and
a reinforcing filler dispersed in the polymeric matrix, the reinforcing filler comprising the pieces of the textile support.

12. The process of claim 11, wherein providing scraps of the composite material comprises providing scraps of imitation leather.

13. The process of claim 12, wherein providing scraps of imitation leather comprises providing scraps of two or more imitation leather materials.

14. The process of claim 13, wherein a weight percentage of the textile support is in a range between 8% and 40% for each of the two or more imitation leather materials.

15. The process of claim 13, wherein a weight percentage of the polymeric material is greater than or equal to 50% for each of the two or more composite materials comprises.

16. The process of claim 11, wherein the polymeric material is selected from: polyvinylchloride, polyurethane, polyester, polypropylene, or mixtures thereof.

17. The process of claim 16, wherein the textile support includes at least one of: natural textile fibers and synthetic textile fibers.

18. The process of claim 17, wherein a fabric type of the textile support is selected from: knitted fabric, warp and weft fabric and non-woven fabric.

19. The process of claim 11, wherein preparing the mixture comprises adding to the scrap pieces a further polymeric material not coming from the scraps, and wherein the further polymeric material is selected from: polyvinylchloride, polyurethane, polyester, polypropylene.

20. The process of claim 11, wherein preparing the mixture comprises:
adding to the scrap pieces an amount of a reinforcing material not coming from the scrap pieces, wherein the reinforcing material is a mineral material comprising a least one of: calcium carbonate, talc, kaolin, sand, and lime.

21. The process of claim 20, wherein the reinforcing material includes at least one plant material selected from: coco fiber/peat, cork, rice husk, banana fiber/peat, lignin, cellulose, tree defibration, and hemp.

22. The process of claim 21, wherein preparing the mixture further includes:
adding to the scrap pieces at least one additive selected from: flame retardants, antioxidants, anti-UV rays and dyes.

23. The process of claim 11, wherein preparing the mixture comprises:
adding to the scrap pieces an amount of wallpaper scrap pieces, wherein the amount of wallpaper scrap pieces is less than or equal to 55% of a mass of the scrap pieces.

24. The process of claim 11, further comprising:
feeding the mixture to an extruding device.

25. The process of claim 24, wherein heating the mixture comprises bringing the blend to a temperature greater than or equal to a melting temperature of the polymeric material and less than or equal to a melting temperature of a material of the textile support.

26. The process of claim 24, wherein heating the mixture comprises bringing the blend to a temperature greater than or equal to 130° C. and less than or equal to 220° C.

27. The process of claim 24, wherein obtaining the granules comprises:
extruding a plurality of sizes of the blend; and
grinding the sizes of blend.

28. A granular infill material for a synthetic turf surface, wherein the granular infill material comprises:
a plurality of granules, wherein each of the plurality of granules includes:
a polymeric matrix comprising a polymeric material; and
a reinforcing filler dispersed in the polymeric matrix, the reinforcing filler comprising pieces of a textile support.

29. The granular infill material of claim 28, wherein the polymeric matrix and the reinforcing filler at least partially derive from scraps of a composite material comprising:
the pieces of the textile support; and
a coating of the textile support, wherein the coating comprises the polymeric material, and wherein a weight percentage of the textile support is greater than or equal to 5% of a total weight of the composite material.

30. The granular infill material of claim 29, wherein:
the polymeric matrix comprises an amount of a further polymeric material not coming from the scraps, wherein the further polymeric material is selected from: polyvinylchloride, polyurethane, polyester and polypropylene;
the reinforcing filler comprises a network of textile fibers originated from pieces of textile support and an amount of a reinforcing material not coming from the scraps, wherein the reinforcing material is a mineral material selected from: calcium carbonate, talc, kaolin, sand, and lime.

31. The granular infill material of claim 30, wherein:
the reinforcing filler further includes a plant material selected from: coco fiber/peat, cork, rice husk, banana fiber/peat, lignin, cellulose, tree defibration, and hemp; and
each of the granules comprises a respective plurality of textile fibers which protrude from an outer surface of the granules.

32. A synthetic turf surface comprising:
a synthetic turf mat; and
a layer of a granular infill material according to claim 28 arranged above the synthetic turf mat.

33. The synthetic turf surface of claim 32, wherein a mass per unit area of the layer of granular infill material is in a range between 3 kg/m² and 20 kg/m².
